(19) United States
(12) Patent Application Publication
(10) Pub. No.: US 2023/0228892 A1
(43) Pub. Date: Jul. 20, 2023

(54) DETECTOR PROTECTION METHOD FOR PROTECTING FLAT DETECTORS FOR ELECTROMAGNETIC RADIATION AND/OR PARTICLE RADIATION, AND DETECTOR PROTECTION ASSEMBLY

(71) Applicant: Christian-Albrechts-Universitaet zu Kiel, Kiel (DE)

(72) Inventors: Olaf Magnussen, Altenholz (DE); Matthias Greve, Schwentinental (DE); Timo Fuchs, Kiel (DE)

(21) Appl. No.: 18/011,287

(22) PCT Filed: Jun. 26, 2021
(86) PCT No.: PCT/DE2021/100543

§ 371 Date: Dec. 19, 2022

(30) Foreign Application Priority Data
Jul. 1, 2020 (DE) 10 2020 117 386.5

(51) Int. Cl. G01T 7/00; G21F 3/00

(52) U.S. Cl. CPC G01T 7/00; G21F 3/00

(57) ABSTRACT

A method and assembly for protecting flat detectors for electromagnetic radiation and/or particle radiation from excessive local intensities in an experiment to be conducted. Multiple absorbers are intelligently positioned in front of sections of a detector area, and further disclosing a detector protection arrangement for protecting area detectors for electromagnetic radiation and/or particle radiation from excessive local intensities.

The invention relates to a detector protection method for protecting area detectors of electromagnetic radiation and/or particle radiation from excessive local intensities in an experiment to be conducted, wherein multiple absorbers are positioned in front of sections of a detector area.

Furthermore, the invention relates to a detector protection arrangement for protecting area detectors for electromagnetic radiation and/or particle radiation from excessive local intensities.

One- and two-dimensional area detectors are increasingly used at synchrotron sources, with prices ranging from 100 T EUR to 2M EUR. In general, weak signals (1-10⁵ photons/s) are to be measured with them, but very high X-ray intensities (>10⁷ photons/s) occur selectively at certain positions. Depending on the type of detector, these can distort weak signals of neighboring areas and even destroy the pixels of the detector and/or the electronics behind it. To prevent such destruction, the corresponding detector areas are covered with X-ray absorbers, which are placed manually. However, the precise positioning of many such absorbers can become very time-consuming and thus take up a significant part of the scarce measurement time at synchrotron measuring stations.

Analogous problems exist at modern experimental facilities for particle beams, such as high-flux reactors and spallation sources for neutrons, and for measurements in other regions of the electromagnetic spectrum, such as large astronomical telescopes.

The present invention relates to an intelligent method for simple and fast positioning of multiple absorbers. To this end, the current definition of AI will first be considered, namely: “Artificial intelligence (AI) deals with methods that enable a computer to solve such tasks that, when solved by humans, require intelligence.”

[https://wirtschaftslexikon.gabler.de/definition/kuenstliche-intelligenz-ki-40285/version-263673] and further that of the “intelligent agent”: “An intelligent agent is anything that perceives its environment through sensors and acts upon the environment through actuators.” (according to: P. Norvig and S. Russell: Artificial intelligence: A Modern Approach, Prentice Hall, 3rd edition resp. P. Norvig and S. Russell: Künstliche Intelligenz: Ein moderner Ansatz, Pearson Studium, 3rd edition)

It can be stated that the subject treated by the invention concerns among others this area. In the state of the art, some options are already known to position corresponding absorbers.

DE 10 2011 108 876 A1 discloses an X-ray detector that has a unit that allows positioning of an X-ray absorber relative to the components to be protected during measurement.

EP 3 258 254 A1 describes an aperture system for protecting a detector in a goniometer.

The publication EP 3 285 065 A1 discloses a movable shield for protecting an area detector from excessive X-ray intensity during operation of a goniometer, whereby the movements of the detector and the shield are coordinated.

All these inventions have in common that in each case only a single contiguous area of the detector is covered by an absorber or exposed by an aperture system. This is the general state of the art and is realized at many measuring stations of synchrotron sources.

Furthermore, an aperture system for the partial absorption of gamma radiation for use in radiation diagnostics and radiation therapy is known from the publication DE 44 27 037 A1, wherein an aperture system for the partial absorption of gamma radiation, in particular in X-ray examinations and treatments, preferably in digital subtraction angiography, as well as in gamma radiation therapy, is provided for arrangement in the region of the radiation exit surface of a gamma radiation source.

The problems in the state of the art are essentially that there is no fast efficient method so far that allows area detectors to be protected from too high local intensities at several, independent positions at the same time. Currently, this can only be done by manual placement, which is very time-consuming and difficult for inexperienced users due to the required high positioning accuracy of about 100 μm. In addition, a new placement is required for each change of sample or experimental geometry. Since measurement time at synchrotron measuring stations is limited and associated with high costs, measurements requiring absorbers at multiple positions can currently only be carried out very sporadically, and experiments that would require frequent repositioning of the absorbers are not technically feasible.

The present invention is based on the task of disclosing a detector protection method for protecting area detectors for electromagnetic radiation and/or particle radiation from excessive local intensities, wherein absorbers are intelligently positioned in front of sections of a detector area, and further disclosing a detector protection arrangement for protecting area detectors for electromagnetic radiation and/or particle radiation from excessive local intensities.

This task is solved with a detector protection method according to claim 1. The main task is further solved with a detector protection arrangement according to the claim 9.

The detector protection method for protecting area detectors for electromagnetic radiation and/or particle radiation from excessive local intensities in an experiment to be conducted, wherein multiple absorbers are positioned in front of sections of a detector area, the detector protection method comprises the steps of:

1. preparatory configuration:
a. setting a threshold value Iₗᵢₘ for the intensity at a point of the detector area, in accordance with the expected intensity maxima based on the experiment to be performed and the necessary intensity Iₓ, required for conducting the experiment, of the primary beam used for the measurement and in accordance with the maximum intensity to be tolerated by the detector;
b. loading magazines with or providing magazines having absorbers of different shapes and sizes, selected in accordance with the type of experiment to be conducted;

2. determining a position pattern of the absorbers;

3. computer-assisted automatic placing of the absorbers on an absorber carrier on the basis of the position pattern;

4. checking the positions of the placed absorbers and conducting the measurement.

Further, it is particularly preferred that determining a position pattern of the absorbers in step 2 comprises:
a. measuring the sample with strongly reduced intensity Iᵢ of the primary beam;
b. identifying the points where the threshold Iₗᵢₘ on the detector surface has been exceeded and from this creating a binary image B1 with the positions of these points;
c. determining contiguous areas X in B1 and their size, shape and distribution;
d. selecting the number and shape of the required absorbers;
e. generating a list L corresponding to the position pattern of positions, shapes and orientations of the absorbers to be placed according to the position pattern.

Furthermore, it is particularly preferred that, for the computer-assisted automatic placing of the absorbers on the absorber carrier in step 3 the following is carried out on the basis of a list L corresponding to the position pattern:
a. an assignment of the selected absorbers to magazines of the detector arrangement;
b. determining the order of placement of the absorbers;
c. moving the absorbers onto the absorber carrier.

Further particularly preferred, the verification of the positions of the placed absorbers in step 4 comprises:
a. creating and evaluating a binary image at greatly reduced intensity II after completion of the positioning step 3c, wherein in the presence of points with exceeding of the threshold value Iₗᵢₘ in the binary image step 4b will be the next step, otherwise further go on to step 4e;
b. checking and, if necessary, correcting the absorber list L according to step 2c to 2e;
c. repeating step 3—computer-assisted automatic placement of the absorbers based on a corrected absorber list L1;
d. repeating step 4a until threshold Iₗᵢₘ is not exceeded at any point in the binary image;
e. checking the placed absorbers by creating a binary image at higher intensity I₂, where I₁<1₂<I_{X}, and steps 4b to 4d are repeated if there are points where the threshold value Iₗᵢₘ is exceeded;
f. repeating step 4d until the intensity 1ₓ required for the measurement is reached.

In a further embodiment, preferably in step 2d the selection of the number and shape of the required absorbers is performed with the following conditions:
i. all areas X are completely covered by an absorber;
ii minimizing the coverage of the areas outside of areas X;
iii. minimizing the number of absorbers to be used.

In particular the determination of a placement order of the absorbers in step 3b is carried out under the condition that the paths to be covered for the positioning include as few changes of direction as possible and are as short as possible.

Further, preferably, the displacement of the absorbers on the absorber carrier in step 3c is carried out taking into account the avoidance of collisions with already placed absorbers and taking into account the following conditions:
i minimizing changes in direction and length of the paths to be covered for positioning;
ii. taking into account the geometrical parameters of the experimental setup.

Additionally preferably, a further step 5 is processed:

5. modifying the position pattern of the placed absorbers when the detector position is changed, wherein the following is carried out for this purpose:
a. recalculation of the absorber list L from the position changes, in accordance with the geometric parameters of the experimental setup;
b. computer-assisted automatic changing of the position pattern by shifting the absorbers on the absorber carrier on the basis of list L and/or, if appropriate, replacement by absorbers of a different shape stored in the magazine, wherein these changes are carried out in accordance with steps 3b and 3c;
c. checking the positions according to step 4.

The detector protection arrangement for protecting area detectors for electromagnetic radiation and/or particle radiation from excessive local intensities, wherein absorbers can be positioned in front of sections of a detector area, wherein the positioning can be carried out by means of a computer-assisted method executed on a computer unit with a computer program in accordance with detector protection methods according to one of the preceding claims, wherein

the detector protection arrangement comprises the following components:
thin planar absorber carrier made of a material with sufficiently high transparency for the radiation measured in the detector; and
absorbers consisting of bodies of highly absorbing material for the radiation present and
magazines for absorbers and
X-Y positioning arm for the displacement of the absorbers on the absorber carrier.

Further preferably the detector protection arrangement further comprises:
absorber manipulator mounted on the X-Y positioning arm, and
stepper motor mounted on the absorber manipulator and having a freely rotatable axis, the manipulator axis, perpendicular to the detector, on which a manipulator holder is mounted by means of which the absorber can be displaced, and/or
a holder for absorber carrier and X-Y positioning arm, which optionally allows direct attachment to the detector or free positioning in space.

Preferably, the invention comprises a robotic system that highly reduces the time of placing the absorbers.

The system can detect detector areas with too high intensities and places the absorbers there with pixel precision, which allows extensive automation of the setting or relocation of the absorbers.

This clearly supports both experienced and new users of the measuring stations and leads to considerable time savings.

Furthermore, new measurement methods can be made possible that have been previously not efficiently feasible.

In particular, expensive detectors are protected from radiation damage by the process as well as the array itself.

The particular advantage of the device or method for protecting area detectors from excessive intensity is that it automates and highly accelerates the placement of the absorbers, including the necessary optimization considerations, by using artificial intelligence. This also allows complex or time-critical measurements to be carried out and also by users with little experience in this field.

Another advantage, in particular of the preferred embodiment with the two round rods MR, is that the absorbers are placed by sliding on a thin absorber carrier, i.e., the movement is performed essentially in the plane, and the space requirement parallel to the surface normal, i.e., along the beam direction, is minimal. This makes it possible to place other measuring elements there, such as evacuated beam tubes.

The following description of the invention is based on a particularly preferred example of an embodiment. However, this is not intended to limit the scope of protection.

In the particularly preferred embodiment, the method comprises the following steps:

1. Configuration:
a. determination of a threshold value Iₗᵢₘ for the intensity at a point on the detector surface, taking into account the expected intensity maxima based on the experiment to be performed and the intensity Iₓ of the primary beam used for the measurement required to perform the experiment, as well as the maximum intensity that can be tolerated by the detector;
b. loading of magazines with absorbers of various shapes and sizes, selected according to the type of experiment to be conducted;

2. determination of a position pattern of the absorbers:
a. measuring the sample with highly reduced intensity of the primary beam I₁;
b. identification of the points where the threshold value Iₗᵢₘ was exceeded on the detector surface and from this creating a binary image B1 with the positions of these points;
c. determination of contiguous areas X in B1 and their size, shape and distribution:
d. selection of the number and shape of the required absorbers with the conditions:
   i. all areas X are completely covered by an absorber;
   ii. Minimize overlap of areas outside of areas X;
   iii. Minimizing the number of absorbers to be used;
e. preparation of a list L of positions, shapes and orientations of the absorbers to be placed for the position pattern;

3. computer-assisted automatic placement of the absorbers on an absorber carrier based on list L
a. assignment of the selected absorbers to the magazines of the apparatus according to the invention;
b. determination of a placement sequence of the absorbers under the condition that the paths to be covered for positioning involve as few changes of direction as possible and are as short as possible;
c. moving the absorbers on the absorber carrier according to known algorithms, taking into account the avoidance of collisions with already placed absorbers and observing the conditions:
   i. minimization of changes in direction and length of travel required for positioning;
   ii. consideration of the geometric parameters of the experimental setup;

4. checking the positions of the placed absorbers:
a. creation and evaluation of a binary image with strongly reduced intensity I₁ after completion of positioning step 3c; in the presence of points with exceeding threshold Iₗᵢₘ in the binary image step 4b will follow, otherwise step 4e will be the next step;
b. review and, if necessary, correct absorber list L according to steps 2c to 2e;
c. repeat step 3—computer-assisted automatic placement of absorbers using the corrected absorber list L1;
d. repeat step 4a until threshold Iₗᵢₘ is not exceeded at any point in the binary image;
e. checking the set absorbers by creating a binary image at higher intensity I₂, where I₁<1₂<Iₓ; repeating steps 4b to 4d in the presence of points exceeding the threshold Iₗᵢₘ;
f. repeat step 4d up to the intensity required for the measurement 1ₓ;

5. modification of the position pattern of the set absorbers when the detector position is changed:
a. recalculation of the absorber list L from the position changes taking into account the geometrical parameters of the experimental setup;
b. computer-aided automatic change of the position pattern by shifting the absorbers on the absorber carrier using list L and/or, if necessary, replacement by absorbers of a different shape stored in the magazine, these changes being made in accordance with steps 3b and 3c;
c. check the positions according to step 4.

The device for conducting the method, which is also in accordance with the invention, can be described as follows, whereby this represents preferred embodiments and is not necessarily to be regarded as limiting the scope of protection of the invention:

The device for protecting area detectors from locally elevated intensities of measured radiation may include, in particular, the following components:
thin planar absorber carrier made of a material with sufficiently high transparency for the radiation measured in the detector. Preferred for X-ray detectors are carbon-based materials (composite carbons, glassy carbons), plastics (Kapton, PEEK) and A1, other suitable materials are other metals (steels), semiconductors (Si), insulators (LiF, NaF, boron nitride, boron carbide, borides), oxides (sapphire, quartz, boron oxide, borosilicate). These semiconductors, insulators and oxides can also be used for absorber carriers for electromagnetic radiation in the infrared (IR), visible (Vis) and ultraviolet (UV) regions. The thickness of the absorber carrier is between 0.05 m and 5 mm, height and width are determined by the dimensions of the detector area (typically between 10×10 mm² and 1000×1000 mm²).
Absorbers consisting of bodies of highly absorbing material for the radiation at hand, having a defined thickness (0.5 to 20 mm) perpendicularly and a predetermined shape parallel to the detector plane. The highly absorbing materials are mounted on magnets of smaller dimensions in the detector plane and are held in a stable position by counter magnets located on the other side of the absorber carrier. The shapes of the absorbers are optionally circles, ellipses, crescents and rectangles with dimensions between 1 and 50 mm. For X-ray absorbers, heavy metals (W, Ta, Pb, Bi) are preferably used. For special applications other materials (especially elementary metals and semiconductors) can be used, the choice of which depends on the wavelength of the radiation and the position of the X-ray absorption edges in the material. For IR, Vis and UV radiation, highly absorbing materials made of easily machinable metals (A1, steels) with highly absorbing coatings (black emitters) are preferred.
Magazines for absorbers located along one or more sides of the absorber carrier. The magazines allow insertion and initial placement of absorbers at specified positions of the absorber carrier.
X-Y positioning arm for moving the absorbers on the absorber carrier. The X-Y positioning arm allows the movement of the absorber manipulator along two axes in the detector plane via stepper motors. The position accuracy is smaller than the size of a single detector dot. Optical or magnetic length encoders can optionally be used to control the position and ensure position accuracy. The position of the absorbers can optionally also be checked via a camera on the absorber carrier or on the X-Y positioning arm.
Absorber manipulator mounted on the X-Y positioning arm.
Stepper motor mounted on the absorber manipulator, which has a freely rotatable axis, the manipulator axis, perpendicular to the detector, on which a manipulator holder is mounted, with which the absorber can be moved.
Bracket for absorber carrier and X-Y positioning arm, allowing either direct attachment to the detector or free positioning in the room.
Electronic control unit for controlling the motor movements of the X-Y positioning arm and absorber manipulator, the control unit preferably including a small computer or microcontroller for calculating the movements.
In a preferred embodiment, when circular absorbers are used (with radii between Rₘᵢₙ and Rₘₐₓ), the manipulator is formed by a rod holder on which two axially parallel round rods are eccentrically mounted, the round rods having a radius r between 1 and 5 mm and being made of metal, preferably stainless steel, have distances ≥r+Rₘₐₓ from the manipulator axis and a maximum pick-up angle α≤140° is ensured by a distance d=2(r+Rₘᵢₙ)−sin(α/2) of the round rods, wherein the movement of the absorbers is performed as follows:
   i) Moving the manipulator towards the absorber until it is touched by both round bars;
   ii) Rotation of the manipulator holder around the center of the absorber axis until the round bars are positioned in the opposite direction to the intended traverse;
   iii) movement of the X-Y positioning arm with absorber in the same direction up to the desired final position where changes of direction are realized by rotations of the manipulator holder around the center of the absorber axis, and
   iv) after reaching the target position, final movement of the X-Y positioning arm to a position in which the experiment to be performed is not disturbed by the X-Y positioning arm, avoiding contact with already placed absorbers.

In this embodiment, it is possible to detect the contact of the round bars with the absorbers by means of an electrical measurement and thus to determine the position of the absorbers. In an alternative embodiment, when non-circular absorbers are used, an alternative version of absorber manipulator may be used that allows fixed gripping of absorbers. For this purpose, for example, a motorized or electromagnetically displaceable third rod can be mounted. on the manipulator rod, which can be moved towards the circular rods, thus allowing gripping of absorbers.

In another embodiment, the manipulator holder has a device which is positioned centrally above the absorber and which lifts the absorber electromagnetically or by means of negative pressure generated by a pump, whereby the absorbers can be lifted off the absorber holder by 0.1 to 2 mm and transported. The counter magnet is magnetically carried along.

Further embodiments include manipulator holders in which motorized, electromagnetic or compressed air driven vertical movements can be used to insert a molded part, e.g. pyramid, cross, hexagon, into a corresponding mating mold mounted on the absorber and subsequently rotate and move it over the absorbers,

The manipulator bars with different - and d can be interchanged to cover different ranges of radii Rₘᵢₙ and R .ₘₐₓ

The invention to react to the changing load situation of the detector during and due to the measurement by repositioning the absorbers and to do this automatically and not “manually” is also new and inventive in itself.

In particular, it is a computer-aided or computer-assisted method that autonomously and automatically protects an area detector from excessive local radiation intensities by detecting areas at risk, deriving a course of action from this, creating a protection pattern, placing protective absorbers based on this pattern, and verifying the results of this course of action. In the method according to the invention for protecting area detectors for electromagnetic radiation or particle beams, in particular 2D X-ray detectors, against excessive local intensities at multiple positions on the detector, the device autonomously detects areas with excessive intensity and covers them with absorbers. The selection of the absorbers from a set of different basic shapes and their sequential placement is done autonomously without any intervention by the user.

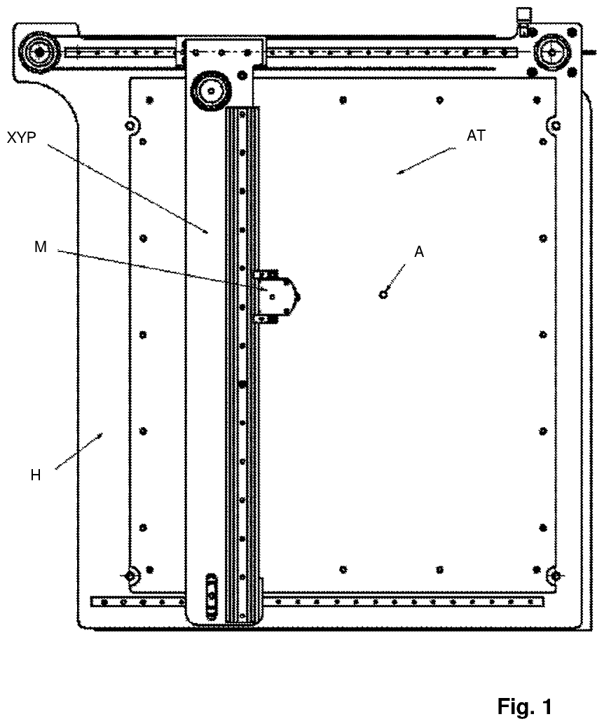

FIG. 1 shows an example (not necessarily limiting the scope of protection) of a device for the protection of area detectors, consisting of a holder H, an absorber carrier AT, absorbers A, X-Y positioning arm XYP and absorber manipulator M.

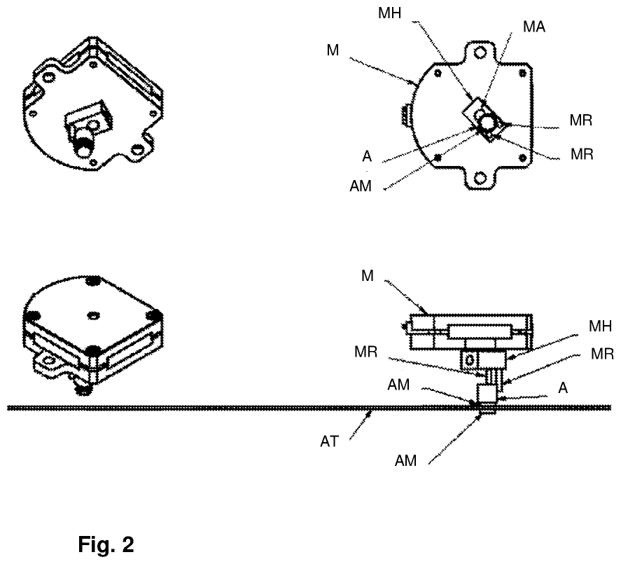

FIG. 2 shows a detailed drawing of the manipulator M with manipulator holder MH, manipulator axis MA, round rods MR and an absorber A held on the absorber carrier AT by magnets AM as an example (not necessarily to be regarded as limiting the protected area).

1. A detector protection method for protecting area detectors for electromagnetic radiation and/or particle radiation from excessive local intensities in an experiment to be conducted, wherein multiple absorbers are positioned in front of sections of a detector area,
the detector protection method comprising the steps of:
1. preparatory configuration:
a. setting a threshold value Iₗᵢₘ for the intensity at a point of the detector area, in accordance with the expected intensity maxima based on the experiment to be performed and the necessary intensity Iₓ, required for conducting the experiment, of the primary beam used for the measurement and in accordance with the maximum intensity to be tolerated by the detector;
b. loading magazines with or providing magazines having absorbers of different shapes and sizes, selected in accordance with the type of experiment to be conducted;
2. determining a position pattern of the absorbers;
3. computer-assisted automatic placing of the absorbers on an absorber carrier on the basis of the position pattern; and
4. checking the positions of the placed absorbers and conducting the measurement.

2. The detector protection method according to claim 1, wherein
determining a position pattern of the absorbers in step 2 comprises:
a. measuring the sample with strongly reduced intensity I₁ of the primary beam;
b. identifying the points where the threshold Iₗᵢₘ on the detector surface has been exceeded and from this creating a binary image B1 with the positions of these points;
c. determining contiguous areas X in B1 and their size, shape and distribution;
d. selecting the number and shape of the required absorbers; and
e. generating a list L corresponding to the position pattern of positions, shapes and orientations of the absorbers to be placed according to the position pattern.

3. The detector protection method according to claim 1, wherein
for the computer-assisted automatic placing of the absorbers on the absorber carrier in step 3 the following is carried out on the basis of a list L corresponding to the position pattern:
a. an assignment of the selected absorbers to magazines of the detector arrangement;
b. determining the order of placement of the absorbers; and
c. moving the absorbers onto the absorber carrier.

4. The detector protection method according to claim 2, wherein
the verification of the positions of the placed absorbers in step 4 comprises:
a. creating and evaluating a binary image at greatly reduced intensity I₁ after completion of the positioning step 3c, wherein in the presence of points with exceeding of the threshold value Iₗᵢₘ in the binary image step 4b will be the next step, otherwise further go on to step 4e;
b. checking and, if necessary, correcting the absorber list L according to step 2c to 2e;
c. repeating step 3—computer-assisted automatic placement of the absorbers based on a corrected absorber list L1;
d. repeating step 4a until threshold Iₗᵢₘ is not exceeded at any point in the binary image;
e. checking the placed absorbers by creating a binary image at higher intensity I₂, where I₁<1₂<Iₓ, and steps 4b to 4d are repeated if there are points where the threshold value Iₗᵢₘ is exceeded; and
f. repeating step 4d until the intensity lₓ required for the measurement is reached.

5. The detector protection method according to claim 2, wherein in step 2d the selection of the number and shape of the required absorbers is performed with the following conditions:
i. all areas X are completely covered by an absorber;
ii minimizing the coverage of the areas outside of areas X; and
iii. minimizing the number of absorbers to be used.

6. The detector protection method according to claim 3, wherein
the determination of a placement order of the absorbers in step 3b is carried out under the condition that the paths to be covered for the positioning include as few changes of direction as possible and are as short as possible.

7. The detector protection method according to claim 3, wherein
the displacement of the absorbers on the absorber carrier in step 3c is carried out taking into account the avoidance of collisions with already placed absorbers and taking into account the following conditions:
i minimizing changes in direction and length of the paths to be covered for positioning; and
ii. taking into account the geometrical parameters of the experimental setup.

8. The detector protection method according to claim 3,
wherein
a further step 5 is processed:

5. modifying the position pattern of the placed absorbers when the detector position is changed, wherein the following is carried out for this purpose:
a. recalculation of the absorber list L from the position changes, in accordance with the geometric parameters of the experimental setup;
b. computer-assisted automatic changing of the position pattern by shifting the absorbers on the absorber carrier on the basis of list L and/or, if appropriate, replacement by absorbers of a different shape stored in the magazine, wherein these changes are carried out in accordance with steps 3b and 3c; and
c. checking the positions according to step 4.

9. A detector protection arrangement for protecting area detectors for electromagnetic radiation and/or particle radiation from excessive local intensities, wherein absorbers can be positioned in front of sections of a detector area, wherein the positioning can be carried out by means of a computer-assisted method executed on a computer unit with a computer program in accordance with detector protection methods according to claim 1,
wherein
the detector protection arrangement comprises the following components:
thin planar absorber carrier made of a material with sufficiently high transparency for the radiation measured in the detector; and
absorbers consisting of bodies of highly absorbing material for the radiation present and
magazines for absorbers and
X-Y positioning arm for the displacement of the absorbers on the absorber carrier.

10. The detector protection arrangement according to claim 9,
wherein
the detector protection arrangement further comprises at least one of:
absorber manipulator mounted on the X-Y positioning arm,
stepper motor mounted on the absorber manipulator and having a freely rotatable axis, the manipulator axis, perpendicular to the detector, on which a manipulator holder is mounted by means of which the absorber can be displaced, and
a holder for absorber carrier and X-Y positioning arm, which optionally allows direct attachment to the detector or free positioning in space.
